(19) United States
(12) Patent Application Publication
(10) Pub. No.: US 2015/0349977 A1
(43) Pub. Date: Dec. 3, 2015

(54) Method and System for Transmitting Telematics Data from a Truck to a Telematics Portal

(71) Applicant: WABCO GmbH, Hannover (DE)

(72) Inventors: Rainer Risse, Pattensen-Reden (DE); Axel Stender, Hameln (DE)

(21) Appl. No.: 14/646,449

(22) PCT Filed: Oct. 31, 2013
(86) PCT No.: PCT/EP2013/003283

§ 371 Date: May 21, 2015

(30) Foreign Application Priority Data
Dec. 7, 2012 (DE) 10 1012 023 968.8

(51) Int. Cl. H04L 12/40; H04B 3/54; H04L 29/08; B60R 16/023

(52) U.S. Cl. CPC H04L 12/40032; B60R 16/023; H04B 3/542; H04L 67/12; H04L 2012/40273; H04L 2012/40215

(57) ABSTRACT

In a truck, consisting of a towing vehicle and at least one trailer vehicle, to transmit telematics data to a vehicle-remote telematics portal the telematics data from the trailer vehicle(s) are transmitted via a cable connection to the towing vehicle and sent from the towing vehicle, together with the telematics data from the towing vehicle, to the vehicle-remote telematics portal. Only the towing vehicle has an electronic telematics controller, and the cable connection is used as a PLC line in order to transmit the telematics data from the trailer vehicle(s) to the towing vehicle without the need for additional cable connections.

### FIELD OF THE INVENTION

The present invention generally relates to transmitting telematics data from a truck, consisting of a towing vehicle and at least one trailer vehicle, to a telematics portal that is remote from the vehicle.

### BACKGROUND OF THE INVENTION

Telematics systems for heavy goods vehicles and the trailer vehicles thereof are known per se and are supplied by Applicant, for example. These allow information relating to the vehicle to be recorded thereon and sent wirelessly to a vehicle-external computer (telematics portal), where these data are kept for evaluation. The towing vehicle and the trailer vehicle preferably each have their own telematics systems and transmit the data ascertained thereby to a telematics portal or to different telematics portals separately. Accordingly, both the towing vehicle and the trailer vehicle have a telematics unit, which results both in increased purchase costs and in increased service costs and increased telecommunication costs.

By way of example, the telematics data transmitted to the telematics portal(s) by the telematics units comprise locating, cooling and vehicle condition data that are used to plan freight flexibly, to make optimum use of vehicles and personnel, to plan safely and to work efficiently. They thereby facilitate management of the vehicle fleet by logistics companies.

US 2011/0 279 253 A1 and US 2011/0 281 522 A1 disclose telematics systems for data communication between a truck and a telematics portal. These telematics systems are essentially used to read data on an RFID transponder, which is fitted to a container loaded on a trailer vehicle, by means of a reader arranged on the trailer vehicle, to modulate these data onto an electrical voltage of a power supply line between the towing vehicle and the trailer vehicle and then to modulate them back in order to finally transmit these data wirelessly from the towing vehicle to a fixed telematics portal, so as to process information relating to the container identification and to the site and content thereof on the telematics portal. An RFID transponder can be used for automatically identifying and locating articles using electromagnetic waves.

### SUMMARY OF THE INVENTION

Generally speaking, it is an object of the present invention to provide an improved method and apparatus for transmitting telematics data from a truck comprising a towing vehicle and at least one trailer vehicle to a telematics portal that can be set up and operated inexpensively.

According to one embodiment of the present invention, the trailer vehicle telematics data are transmitted to the towing vehicle via a cable connection and then transmitted from the towing vehicle to the telematics portal that is remote from the vehicle together with towing vehicle telematics data. This method can be set up and operated inexpensively, since only one telematics unit is required in the whole towing vehicle, an existent cable connection, particularly a power supply line, between the towing vehicle and the trailer vehicle can be used, and savings on the service and telecommunication costs are possible.

In order to use the cable connection for the data transmission from the trailer vehicle to the towing vehicle, the digitally available telematics data of the trailer vehicle are modulated onto an electrical supply voltage by a telematics interface and a PLC interface, then transmitted to the towing vehicle via the cable connection for the power supply of the trailer vehicle, converted back into digital data in the towing vehicle by a PLC interface and a telematics interface of the towing vehicle, and then transmitted to the telematics portal that is remote from the vehicle together with the digital telematics data of the towing vehicle.

The designation “PLC” stands for the abbreviation “power line carrier” for which reason the term “PLC interface” can be understood to mean a device that is used to convert digital signals into analog signals and then to modulate them onto an analog carrier voltage. The originally digital data are then transmitted in analog form via the electrical carrier voltage to a destination, where they are converted back into digital data by means of a further PLC interface. These data that are now in digital form again are then supplied to a telematics interface, which supplies these data to a wirelessly operating communication system.

Thus, according to a preferred embodiment of the described method, the trailer vehicle telematics data are available in digital form and are modulated onto the supply voltage for the trailer vehicle as an analog signal via a trailer-based telematics interface and by means of a PLC interface, the trailer vehicle telematics data are then transmitted to the towing vehicle via a cable connection for the power supply to the trailer vehicle, the trailer vehicle telematics data are then converted back into digital trailer vehicle telematics data by a towing-vehicle-based PLC interface and are then supplied to a towing-vehicle-based telematics interface, and the trailer vehicle telematics data are transmitted wirelessly therefrom to the telematics portal that is remote from the vehicle together with digital to ting vehicle telematics data.

In addition, the trailer vehicle telematics data can be transmitted via a cable connection between an electronic brake system that is arranged in the trailer vehicle or between an electronic expansion module and a trailer remote control unit in the towing vehicle, wherein the electronic expansion module can be used to operate supplementary functions in conjunction with the electronic brake system of the trailer vehicle.

Also, the trailer vehicle telematics data can be transmitted between the trailer vehicle and the to towing vehicle in digital form via one or more CAN bus interfaces according to ISO 7638 or ISO 12098 using the data protocol based on ISO 11992, provided that the relevant telematics data are included in the standards in future.

The method according to the inventive embodiments can be used to supply the fleet management of a logistics company with all the relevant data for the towing vehicle and the trailer vehicle, these data being able to comprise, by way of example, the chassis number, the position of the truck or of the trailer vehicle, the travel times, the standing times, a warning when defined areas are left, documentation of distances traveled, the odometer reading, the speed, the cargo weight, the brake pad wear, the tire pressure, the axle loads, action taken in the stability control of the towing vehicle, downloaded data from an operating data memory, the determination of whether a door is open or closed, whether the trailer vehicle is coupled or uncoupled, the current temperature of a cold room in the trailer vehicle, the setpoint value of a cold room temperature, the operating status of a cooling unit, the indication of a defrost cycle for the cold room, an indication of the operating hours of a cooling unit that is operated by the internal combustion engine or that is operated by an electric motor or supplied with power from a battery, and/or an alarm in the event of a temperature discrepancy. These data can be transmitted to the telematics portal that is remote from the vehicle in real time.

A system, in accordance with an embodiment of the present invention, for transmitting telematics data from a truck to a telematics portal that is remote from the vehicle, the truck consisting of a towing vehicle and at least one trailer vehicle, includes an electronic telematics controller, an electronic towing vehicle brake system, a fleet management interface and an antenna-based telematics interface in the towing vehicle, an electronic trailer brake system, optionally in conjunction with an electronic expansion module in the trailer vehicle(s), and a cable connection for supplying power to electrical appliances in the trailer vehicle(s) from the towing vehicle, having at least one PLC interface and at least one telematics interface in the towing vehicle, and at least one PLC interface and at least one telematics interface in the trailer vehicle(s). The PLC interfaces in the trailer vehicle(s) can modulate the trailer vehicle telematics data, which are initially available as digital CAN signals, onto the electrical supply voltage of the cable connection, and the PLC interface in the towing vehicle can convert the trailer vehicle telematics data modulated onto the supply voltage of the cable connection back into digital CAN signals. The towing vehicle telematics data can be transmitted wirelessly to the telematics portal that is remote from the vehicle together with the trailer vehicle telematics data via the antenna-based telematics interface in the towing vehicle.

A trailer remote control can be arranged in the tow vehicle. The trailer remote control has the towing-vehicle-based PLC interface and the towing-vehicle-based telematics interface, for the trailer remote control to be connected to a trailer-based PLC interface and a trailer-based telematics interface via the cable connection, wherein the trailer vehicle telematics data received in the towing vehicle can be forwarded from the trailer remote control to the antenna-based telematics interface. The trailer-based PLC interface and the trailer-based telematics interface may be integrated in the electronic trailer brake system or in the electronic expansion module.

According to another embodiment of this system, the trailer vehicle can be equipped with a rear monitoring system that has a plurality of ultrasonic sensors and the aforementioned electronic expansion module, and the PLC interface associated with the electronic expansion module can be at up to transmit the trailer vehicle telematics data.

In addition, the towing-vehicle-based telematics interface in the towing-vehicle-based trailer remote control can be connected to the towing-vehicle-based electronic telematics controller by means of CAN bus, indirectly via the fleet management interface or directly via CAN bus.

For the purpose of transmitting the telematics data to the telematics portal, the antenna-based telematics interface in the towing vehicle may be set up to send the towing vehicle telematics data and the trailer vehicle telematics data to the telematics portal that is remote from the vehicle via GPRS or as an SMS. The term “GPRS” is intended to be understood to mean a general, packet-oriented radio service for data transmission. The abbreviation “SMS” designates a telecommunication radio service for transmitting short text messages.

As mentioned above, a telematics controller is utilized in an embodiment of the method according to the invention. This controller in the form of a microcomputer has an antenna-based telematics interface that can be used to convert the telematics data of the towing vehicle and of the trailer vehicle into wirelessly sendable signals, in respect of the electronic expansion module, it can be a microcomputer, and it can have an input for CAN bus signals and also a trailer-based telematics interface and a trailer-based PLC interface.

Still other objects and advantages of the present invention will in part be obvious and will in part be apparent from the specification.

The present invention accordingly comprises the features of construction, combination of elements, arrangement of parts, and the various steps and the relation of one or inure of such steps with respect to each of the others, all as exemplified in the constructions herein set forth, and the scope of the invention will be indicated in the claims.

### BRIEF DESCRIPTION OF THE DRAWINGS

The present invention is explained in more detail below on the basis of exemplary embodiments illustrated in the appended drawings, in which:

FIG. 1 shows a truck, consisting of a towing vehicle and a trailer vehicle, with electrical and electronic components arranged thereon, in accordance with an embodiment of the present invention;

FIG. 2 shows the truck shown in FIG. 1 with a different configuration and a different interconnection of the electrical and electronic components, in accordance with another embodiment of the present invention; and

FIG. 3 shows the truck shown in FIG. 1 with configured and interconnecting the electrical and electronic components according to a further embodiment.

### DETAILED DESCRIPTION OF THE PREFERRED EMBODIMENTS

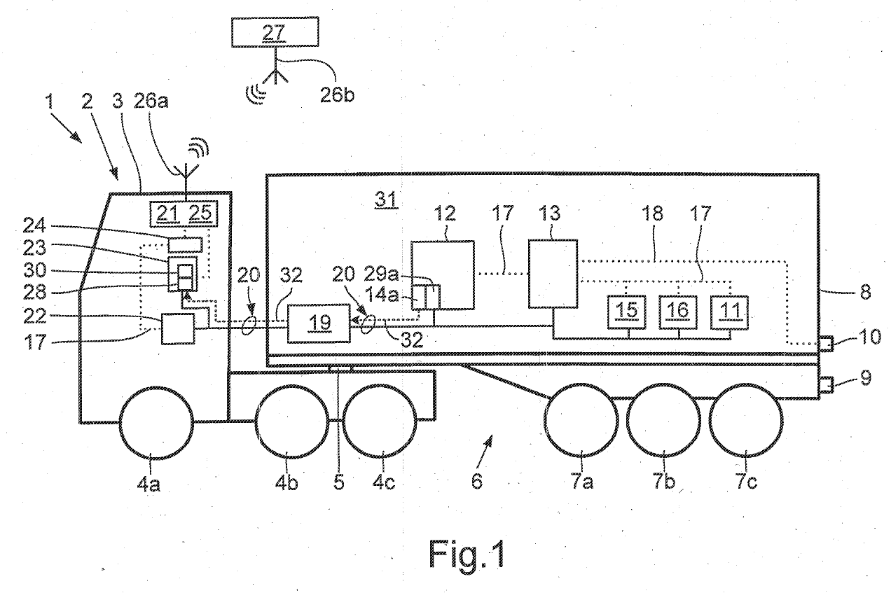

FIG. 1 schematically shows a truck 1 that consists of a towing vehicle 2 and a trailer vehicle 6. The towing vehicle 2 is a semitrailer truck and the trailer vehicle 6 is a semitrailer. Similarly, the towing vehicle 2 could consist of a heavy goods vehicle and the trailer vehicle 6 could consist of a pony trailer. Equally, the towing vehicle 2 could be coupled to a first trailer vehicle 6, and this first trailer vehicle 6 can have a further or else a plurality of trailer vehicle(s) coupled to it.

The towing vehicle 2 has a driver's cab 3, wheels 4a, 4b, 4c and a semitrailer coupling 5, while the trailer vehicle 6 has wheels 7a, 7b, 7e and a cargo space 31. The front wheels 4a of the towing vehicle are steerable, whereas all the other wheels on the truck 1 are not steerable. At the rear 8, the trailer vehicle 6 has outline lights 9 and ultrasonic sensors 10 for a rear monitoring system. The exemplary embodiment shown is a truck 1 for goods that need to be cooled. Accordingly, a cooling unit 11 is arranged on or in the trailer vehicle 6.

The trailer vehicle 6 is equipped with an electronic trailer brake system 12 that reacts to brake operation signals from the driver sitting in the driver's cab 3 and converts them into control commands for brake actuators on the wheels 7a, 7b, 7c of the trailer vehicles 6.

Furthermore, an electronic expansion module 13 is arranged in the trailer vehicle 6 and is connected to the electronic trailer brake system 12 via a CAN bus line 17 shown in dots. A CAN bus is an asynchronous, serial electronic bus system and is used for data-oriented networking of controllers in motor vehicles. The electronic expansion module 13 additionally allows a series of supplementary functions in conjunction with the electronic trailer brake system 12, particularly the operation of the rear monitoring system that has the ultrasonic sensors 10.

The cooling unit 11, a tire pressure monitoring system 16, a display and operator control console 15 and other functional elements that are arranged in or on the trailer vehicle 6 are connected to the electronic expansion module 13 for signaling purposes via CAN bus lines 17.

The ultras lie sensors 10 are connected to the electronic expansion module 13 via a LIN bus 18, which is shown by a dotted line. A LIN bus is intended to be understood to mean a serial communication system for communication by intelligent sensors and actuators in motor vehicles and is based on a single-wire bus. A LIN bus is used where the bandwidth and the versatility of a CAN bus is not needed.

The electronic expansion module 13 communicates with the electronic trailer brake system 12 via the CAN bus 17. The electrical power supply to the electronic trailer brake system 12, the electronic expansion module 13 and the other trailer-based electrical apparatuses 11, 15 and 16 are provided by means of a cable connection 20 from the towing vehicle 2 via a plug connection 19 based on ISO 7638.

The driver's cab 3 contains a towing-vehicle-based electronic telematics controller 21 with an integrated antenna-based telematics interface 25, a towing-vehicle-based electronic brake system 22, a trailer remote control 23 and also further functional elements. The towing-vehicle-based electronic brake system 22 is connected to a fleet management interface 24 via the CAN bus 17 shown by a dotted line. From the towing-vehicle-based electronic brake system 22, the cable connection 20 is routed to the plug connection 19 and to the trailer remote control 23.

The fleet management interface 24 and also the towing-vehicle-based trailer remote control 23 are connected to the telematics controller 21. The towing-vehicle-based antenna 26a thereof can be used to transmit telematics data wirelessly to a telematics portal 27 that is remote from the vehicle. Conversely, it is also possible for the telematics portal 27 to use its portal-based antenna 26b to communicate with the antenna-based telematics interface 25 in the driver's cab 3.

An electrical line 32—shown by a dashed line—of the cable connection 20 for the power supply to the electrical and electronic appliances in the trailer vehicle 6 is used for data transmission of trailer vehicle telematics data to the towing vehicle 2. The cable connection 20 is therefore a PLC line, i.e., a cable connection for signal transmission and for data communication via the power supply cable connection. Alternatively, it is also possible to use a CAN bus line based on ISO 11992.

For the purpose of transmitting trailer vehicle telematics data, the electronic trailer brake system 12 in the exemplary embodiment shown in FIG. 1 has a trailer-vehicle-based PLC interface 14a and a trailer-vehicle-based telematics interface 29a. The telematics data generated by the electronic trailer brake system 12 and the electronic expansion module 13 are converted for the trailer-vehicle-based PLC interface 14a by the trailer-vehicle-based telematics interface 29a and, on the trailer-vehicle-based PLC interface, are modulated onto the supply voltage for the trailer vehicle 6 as an analog voltage signal in the line 32 of the cable connection 20. This is shown for the cable connection 20 merely for the purpose of illustration such that the power supply is provided via the solid line of the cable connection 20, and the telematics data are modulated onto the electrical voltage in the line 32 of this cable connection 20 as an analog signal, as shown symbolically by the dashed line.

The trailer remote control 23 in the driver's cab 3 of the towing vehicle 2 is likewise supplied with electrical power via the cable connection 20 and has a towing-vehicle-based PLC interface 28 and a towing-vehicle-based telematics interface 30 that are used to convert the telematics data of the trailer vehicle 6 that arrive via the PLC cable connection 20 back into digital CAN signals or digital data. These digital data are then routed via the CAN bus 17 to the antenna-based telematics interface 25 together with the telematics data of the electronic towing vehicle brake system 22, and are sent from the antenna-based telematics interface to the external telematics portal 27 via the towing-vehicle-based antenna 26a.

The antenna-based telematics interface 25 may be set up to send the telematics data of the towing vehicle 2 and of the trailer vehicle 6 to the external telematics portal 27 via GPRS or as an SMS.

Controlling and combining the telematics data of the trailer vehicle 6 and of the towing vehicle 2 involves the use of just a single electronic telematics controller 21 in the towing vehicle 2, and there is no need for any kind of additional cable connections between the towing vehicle 2 and the trailer vehicle 6, apart from the cable connection 20, 32 via the plug connection 19 based on ISO 7638.

The trailer vehicle telematics data can comprise at least the chassis number, the position of the truck or of the trailer vehicle, the travel times, the standing times, a warning when defined areas are left, documentation of distances traveled, the odometer reading, the speed, the cargo weight, the brake pad wear, the tire pressure, the axle loads, action taken in the stability control of the towing vehicle, downloaded data from an operating data memory, the determination of whether a door is open or closed, whether the trailer vehicle 6 is coupled or uncoupled, the current temperature of a cold room in the trailer vehicle 6, the setpoint value of a cold room temperature, the operating status of a cooling unit 11, the indication of a defrost cycle for the cold room, an indication of the operating hours of a cooling unit 11 that is operated by the internal combustion engine or that is operated by an electric motor or supplied with power from a battery, and/or an alarm in the event of a temperature discrepancy. These data are transmitted to the telematics portal 27 that is remote from the vehicle in real time.

This telematics portal 27 is part of a fleet management system that also receives and processes the relevant data of the towing vehicle 2 together with the telematics data of the trailer vehicle 6, which is why the fleet management interface 24 is present in the towing vehicle 2. The fleet management interface 24 can be used to poll the most important operating data of the towing vehicle 2, such as vehicle speed, consumption, tank filling level, axle loads, operating hours, vehicle identification number, tachograph data, odometer reading, cooling water temperature, ambient temperature driver identification and many other operating data and to send them to the telematics portal 27 together with the telematics data of the trailer vehicle 6, in the telematics portal 27, these data can be processed for the fleet management of the relevant logistics company in order to be able to plan freight flexibly, to make optimum use of vehicles and personnel, to plan safely and to work efficiently.

The trailer-vehicle-based display and operating control console 15 and the towing-vehicle-based trailer remote control 23 in the driver's cab 3 allow the vertical level of the trailer vehicle 6 and a lift axle control that is possibly present to be influenced by the driver directly on the trailer vehicle 6 or from the driver's cab 3. These influencing options are advantageous when coupling and uncoupling the trailer vehicle 6 to/from the towing vehicle 2, when maneuvering and on empty runs in order to reduce tire wear on the wheels 7a, 7b, 7c of the trailer vehicle 6.

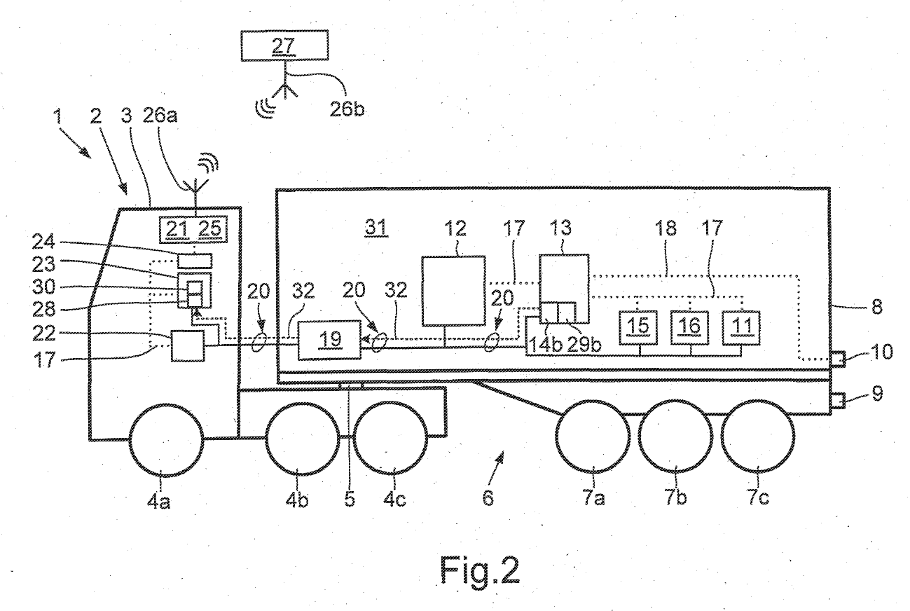

In contrast to the embodiment in FIG. 1, FIG. 2 shows a truck 1 in which, in the towing vehicle 2, the trailer vehicle telematics data are first fed into the CAN-Bus 17 via the towing-vehicle-based PLC interface 28 and the towing-vehicle-based telematics interface 30 by the towing-vehicle-based trailer remote control 23, from which CAN bus these trailer vehicle telematics data reach the telematics controller 21 with the antenna-based telematics interface 25 via the fleet management interface 24.

Furthermore, FIG. 2 shows, in the region of the trailer vehicle 6, that a trailer-based telematics interface 29b and a trailer-based PLC interface 14b are arranged on the electronic expansion module 13 and not on the electronic trailer brake system 12. Accordingly, all trailer-relevant data (including from the electronic trailer brake system 12) are supplied to the electronic expansion module 13 via the trailer-based CAN bus 17, are organized thereon and are modulated onto the trailer supply voltage in the electrical line 32 in the PLC interface 14b. This line 32 is routed, as in the exemplary embodiment in FIG. 1, via the plug connection 19 to the trailer remote control 23 in the towing vehicle 2, where the data are digitized again and then supplied to the telematics controller 21 via CAN bus 17.

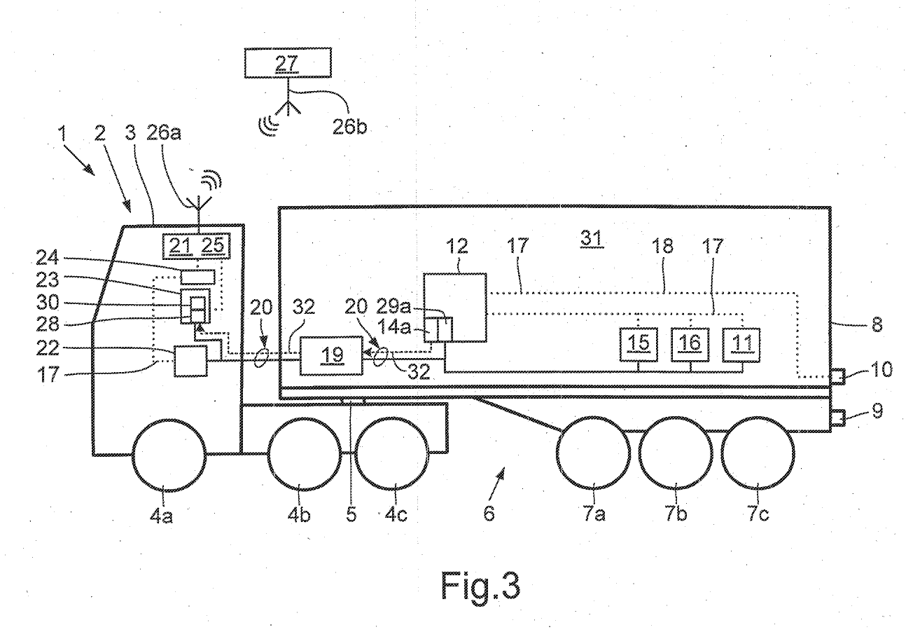

FIG. 3 shows a truck 1 whose electrical and electronic components are almost of the same design as those of the truck shown in FIG. 1. However, it can be seen that the trailer vehicle 6 does not have an electronic expansion module 13, but rather the electronic trailer brake system 12 or the controller installed therein collects all the trailer-relevant telematics data, converts them into at least one analog signal and modulates this signal onto the supply voltage of the electrical line 32 that is routed via the plug connection 19 to the trailer remote control 23 in the towing vehicle 2, where the data are digitized again and supplied to the telematics controller 21.

It will thus be seen that the objects set forth above, among those made apparent from the preceding description, are efficiently attained, and since certain changes may be made without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention that, as a matter of language, might be said to fall therebetwen.

What is claimed is:

1. A method for transmitting telematics data from a truck including a towing vehicle and at least one trailer vehicle to a remote telematics portal, the method comprising transmitting trailer vehicle telematics data to the towing vehicle via a cable connection, and transmitting the trailer vehicle telematics data from the towing vehicle to the remote telematics portal together with towing vehicle telematics data.

2. The method as claimed in claim 1, wherein the trailer vehicle telematics data are in digital form and are modulated onto a supply voltage for the at least one trailer vehicle by a trailer-based telematics interface via a trailer-based PLC interface, wherein the trailer vehicle telematics data are-then transmitted to the towing vehicle via a cable connection for the power supply to the at least one trailer vehicle, wherein the trailer vehicle telematics data are converted back into digital trailer vehicle telematics data by a towing-vehicle-based PLC interface and are supplied to a towing-vehicle-based telematics interface, and wherein the trailer vehicle telematics data are transmitted wirelessly to the remote telematics portal together with digital towing vehicle telematics data.

3. The method as claimed in claim 1, wherein the trailer vehicle telematics data are transmitted via a cable connection between an electronic brake system arranged in the at least one trailer vehicle or an electronic expansion module and a trailer remote control unit in the towing vehicle, and wherein the electronic expansion module is operable to effect supplementary functions in conjunction with the electronic brake system.

4. The method as claimed in claim 1, wherein the trailer vehicle telematics comprise at least a chassis number, a position of the truck or of the at least one trailer vehicle, travel times, standing times, a warning when defined areas are crossed, documentation of distances traveled, odometer reading, speed, cargo weight, brake pad wear, tire pressure, axle loads, action taken in stability control of the towing vehicle, downloaded data from an operating data memory, an indication of whether a door is open or closed, an indication of whether the at least one trailer vehicle is coupled or uncoupled, current temperature of a cold room in the at least one trailer vehicle, a setpoint value of a cold room temperature, operating status of a cooling unit, an indication of a defrost cycle for the cold room, an indication of operating hours of the cooling unit, and an alarm in the event of a temperature discrepancy.

5. The method as claimed in claim 1, wherein the trailer vehicle telematics data are transmitted from the at least one trailer vehicle to the towing vehicle via a separate CAN bus line.

6. A system for transmitting telematics data from a truck to a remote telematics portal, the truck including a towing vehicle and at least one trailer vehicle, the system comprising an electronic telematics controller; an electronic towing vehicle brake system; a fleet management interface and an antenna-based telematics interface in the towing vehicle; an electronic trailer brake system in the at least one trailer vehicle; an electronic expansion module in the at least one trailer vehicle; a cable connection for supplying power to electrical devices in the at least one trailer vehicle from the towing vehicle; at least one PLC interface and at least one telematics interface in the towing vehicle; and at least one PLC interface and at least one telematics interface in the at least one trailer vehicle; wherein the at least one PLC interface in the at least one trailer vehicle is configured to modulate trailer vehicle telematics data initially available as digital CAN signals onto an electrical supply voltage of the cable connection, wherein the at least one PLC interface in the towing vehicle is configured to convert the trailer vehicle telematics data modulated onto the electrical supply voltage of the cable connection back into digital CAN signals, and wherein the towing vehicle telematics data is transmittable wirelessly to the remote telematics portal together with the trailer vehicle telematics data via the antenna-based telematics interface in the towing vehicle.

7. The system as claimed in claim 6, further comprising a trailer remote control in the towing vehicle, the trailer remote control including the at least one PLC interface in the towing vehicle and the at least one telematics interface in the towing vehicle, the trailer remote control being connected to one of the at least one PLC interface in the at least one trailer vehicle and to one of the at least one telematics interface in the at least one trailer vehicle via the cable connection, wherein the trailer vehicle telematics data can be forwarded from the trailer remote control to the antenna-based telematics interface.

8. The system as claimed in claim 6, wherein one of: (i) the one of at least one PLC interface in the at least one trailer vehicle and the one of the at least one telematics interface in the at least one trailer vehicle are integrated in the electronic trailer brake system, and (ii) another of the at least one PLC interface in the at least one trailer vehicle and another of the at least one telematics interface in the at least one trailer vehicle are integrated in the electronic expansion module.

9. The system as claimed in claim 8, wherein the at least one trailer vehicle has a rear monitoring system that has a plurality of ultrasonic sensors and the electronic expansion module, and wherein the another of the at least one PLC interface in the at least one trailer vehicle associated with the electronic expansion module is configured to transmit the trailer vehicle telematics data.

10. The system as claimed in claim 6, wherein the antenna-based telematics interface in the towing vehicle is configured to send the towing vehicle telematics data and the trailer vehicle telematics data to the remote telematics portal wirelessly via GPRS or as an SMS.

11. The system as claimed in claim 6, wherein the at least one telematics interface in the towing vehicle is connected to the electronic telematics controller by a CAN bus one of indirectly via the fleet management interface and directly by the CAN bus.

12. A telematics controller configured to effect transmission of telematics data of a trailer Thiele to a towing vehicle and transmission of the telematics data and towing vehicle telematics data from the towing vehicle to a remote telematics portal, the telematics controller comprising an antenna-based telematics interface configured to convert the towing vehicle telematics data and the telematics data of the trailer vehicle into wirelessly sendable signals.

13. An electronic expansion module in the form of a microcomputer configured to effect transmission of telematics data of a trailer vehicle to a towing vehicle and transmission of the telematics data and towing vehicle telematics data from the towing vehicle to a remote telematics portal, the electronic expansion module comprising an input for CAN bus signals; a trailer-based telematics interface and a trailer-based PLC interface.
